(19) United States
(12) Patent Application Publication
(10) Pub. No.: US 2012/0030875 A1
(43) Pub. Date: Feb. 9, 2012

(54) HOSPITAL BED HAVING REMOVABLE HEADBOARD

(76) Inventor: Hans-Peter Barthelt, Esslingen (DE)

(21) Appl. No.: 13/131,830

(22) PCT Filed: Nov. 25, 2009
(86) PCT No.: PCT/EP2009/008399

§ 371 Date: Oct. 19, 2011

(30) Foreign Application Priority Data
Dec. 1, 2008 (DE) 102008059733.3

(51) Int. Cl. A61G 7/00

(52) U.S. Cl. 5/600

(57) ABSTRACT

A hospital bed (1) has a removable headboard (11). The removable headboard is provided with a handle bar (12), the free ends of which sit on the upper frame (4) of the lifter (2). In order to connect the handle bar to the lifter, inserting pins (22) are provided on the lifter. Said inserting pins are designed such that neither during insertion nor during removal of the headboard (11) from the inserting pins any clamping effect can occur.

### CROSS-REFERENCE TO RELATED APPLICATIONS

This patent application is the national phase of PCT/EP2009/008399, filed Nov. 25, 2009, which claims the benefit of German Patent Application No. 102008059733.3, filed Dec. 1, 2008.

### FIELD OF THE INVENTION

The present invention relates generally to hospital beds, and more particularly, to a hospital bed having a removable headboard.

### BACKGROUND OF THE INVENTION

Hospital beds typically have a footboard at the foot end and a headboard at the head end. They are needed in order to change the beds and in order to optionally fasten other devices to them. The headboard, however, is in the way when a collapsed patient is to be resuscitated. The doctor performing the resuscitation must bend over the patient from the head of the bed. This makes it difficult unless the headboard is removed from the bed.

Therefore, the headboard must be detachably connected to the bed frame. Up to now, cylindrical posts that project into receptacle sockets have been used as the connection mechanism. The receptacle socket can be formed by a tube that is provided as a handlebar on the headboard or by a corresponding socket fastened on the bed frame. The disadvantage of this arrangement is that it tends to become easily jammed, which significantly delays the removal of the headboard in terms of time.

From a manufacturing standpoint, the socket-post connection presents a problem in so far as the tube surrounding the insert post of the headboard is subjected to significant tolerances due to the bending process and also the insertion sockets on the bed frame are subject to tolerances with respect to position. This requires either an adjustment or else an extremely large play between the post and socket.

### OBJECTS AND SUMMARY OF THE INVENTION

It is an object of the invention to provide a hospital bed with a headboard adapted for easier and more reliable installation and removal from the frame of the bed.

The hospital bed according to the invention has a bed frame with a headboard at a head end that is connected to the bed frame by means of two connection mechanisms. A tubular receptacle socket that has a continuous, cylindrical, smooth inner space is a part of each connection mechanism. Furthermore, an insertion post that has two flat sides parallel to each other is also a part of the connection mechanism. The thickness of the insertion post, measured as the distance between the flat sides, is significantly smaller than the internal diameter of the receptacle socket. The ratio of thickness to diameter is about 1:3, i.e., the diameter is about 3 to 3.5 times larger than the distance of the flat sides from each other.

The insertion posts are advantageously oriented relative to the bed so that the flat sides lie parallel to the longitudinal axis of the bed. In this way, distance variations with respect to the distance between the receptacle sockets can be compensated to a relatively large extent, while the displacement of the receptacle sockets in the longitudinal direction of the bed and thus the possibility of tilting the headboard is insignificant. This follows from the fact that, at small angles, the sine function changes very greatly, while the cosine function undergoes only a small change.

If the insertion post is a plate, then the insertion post has a rectangular cross section at least at the positions that are essential to the function. The use of a plate as the insertion post also has the advantage that the insertion post can be easily manufactured as a laser-cut part, which significantly reduces, on one hand, the production costs and, on the other hand, the amount of material to be used.

In order to achieve the desired effect, each diagonal of the cross-sectional profile of the insertion post running at a right angle to the longitudinal axis of the insertion post has a length that is shorter than the internal diameter of the receptacle socket.

Favorable relationships are produced when two support sections are formed on the insertion post that are spaced apart from each other along the insertion post. Through the spacing of the support sections, when the connection mechanism is pushed together, jamming is essentially avoided.

It has proven favorable when the longest diagonal in the crosss-sectional profile of the insertion post is between 0.5 and 3 mm, and advantageously between 0.5 and 1.5 mm, shorter than the diameter of the insertion socket. The support sections can be constructed on or next to the respective end of the insertion post.

One of the support sections could be hexagonal when viewed onto the flat side, and advantageously could have the shape of an elongated hexagon with two longitudinal edges parallel to each other and parallel to the longitudinal axis of the insertion post.

The largest widths of the two support sections can be equal, i.e., the dimension in the direction transverse to the longitudinal axis of the one support section being equal to the transverse dimension of the other support section.

The two support sections are arranged next to the ends of a waist section set away from each other. Its width is significantly smaller than the width of the support sections, measured in the plane of the flat side. Advantageously, the width and the length of the waist section are selected so that the insertion post can no longer become jammed when the second support section is inserted into the socket. The waist section advantageously has the construction of a rectangle when looking onto the flat side, optionally with a transition section.

Favorable installation relationships can be produced when the insertion post is arranged on the bed frame. In this case, as the socket, the inner space of the handlebar that surrounds the plate insert can be used.

Instead of a hospital bed with an insertion post manufactured from a flat material, an insertion post made from round material could also be used. Such an insertion post would be symmetrically round and two support sections spaced apart from each other could be constructed on it. The support sections and the waist section lying in-between could be constructed in the cross section as explained above in connection with plate-shaped insertion posts. Here, the view onto the flat side corresponds to the corresponding sections in the longitudinal section of the rotationally symmetric insertion post.

Other objects and advantages of the invention will become apparent upon reading the following detailed description and upon reference to the drawings, in which:

### BRIEF DESCRIPTION OF THE DRAWINGS

FIG. 1 is an exploded view of the hospital bed according to the invention; and

FIG. 2 is an exploded view of one of the connection mechanisms for connecting the headboard to bed frame of the illustrated bed as viewed onto the flat side of the insertion post.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

More particularly, the following description of figures explains an understanding of the invention. Additional details that are not described can be inferred by someone skilled in the art in the usual way from the drawings that, in this respect, supplement the description of the figures. It is clear that a series of modifications are possible.

The drawings also are not necessarily to scale. For the illustration of details, certain areas possiby could be shown excessively large. In addition, the drawings are simplified and do not contain each detail optionally present for the practical construction. The terms “top” and “bottom” or “front” and “back” or “right” and “left” refer to the normal position of use or the terminology for beds.

### DESCRIPTION OF THE PREFERRED EMBODIMENTS

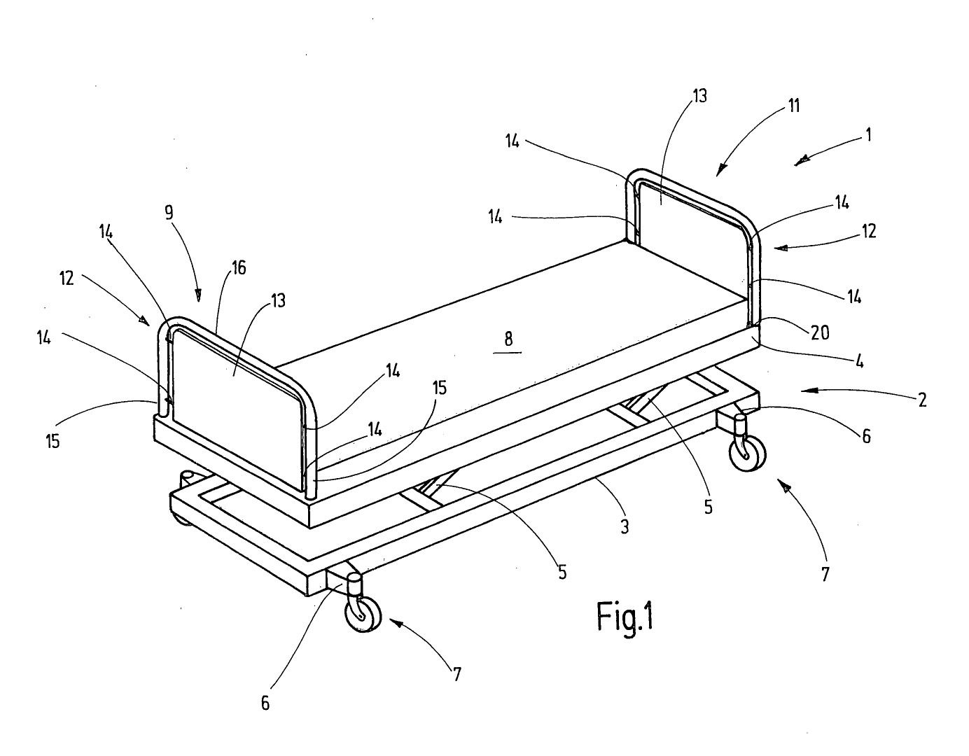

Referring now more particularly to FIG. 1 of the drawings, there is shown an illustrative hospital bed 1 in accordance with the invention. The illustrated hospital bed, includes a lifter 2 that has a lower lifter frame 3 and an upper lifter frame 4. The two frames 3,4 are connected to each other by means of a lifter mechanism 5 so that the distance between the lower frame 3 and the upper frame 4 can be varied in the way that is typical for hospital beds. On the lower frame 3 there are extensions 6 on which steerable wheels 7 are mounted. Each steerable wheel 7 is located next to one corner of the lower frame 3 which is rectangular when viewed from the top.

Within the upper frame 4 there is a horizontal frame that is divided in a conventional way for supporting a mattress lying on top. By virtue of such horizontal frame, the individual sections of the mattress 8 can be raised in the back and leg regions in a known way. Together with the horizontal frame, the lifter 2 basically forms the bed frame.

At the foot end of the bed there is a footboard 9 and at the head end there is a headboard 11. The footboard 9 is fastened rigidly, while the headboard 11 is removable, in order to be able to facilitate performing a resuscitation of a patient on the bed.

The footboard is assembled from a U-shaped, bent tube 12 and an insert plate 13 sitting in the corresponding opening defined by the tube. The insert plate 13 is connected to the tube 12 by means of a total of four holding elements 14.

The tube is bent so that it has two straight legs 15 that run parallel to each other and a middle section 16 running at a right angle to the legs 15 and parallel to the base. The headboard 11 is constructed in the same way, but with the difference that the U-shaped, bent tube 12 is connected to the upper frame 4 by means of two connection mechanisms 20.

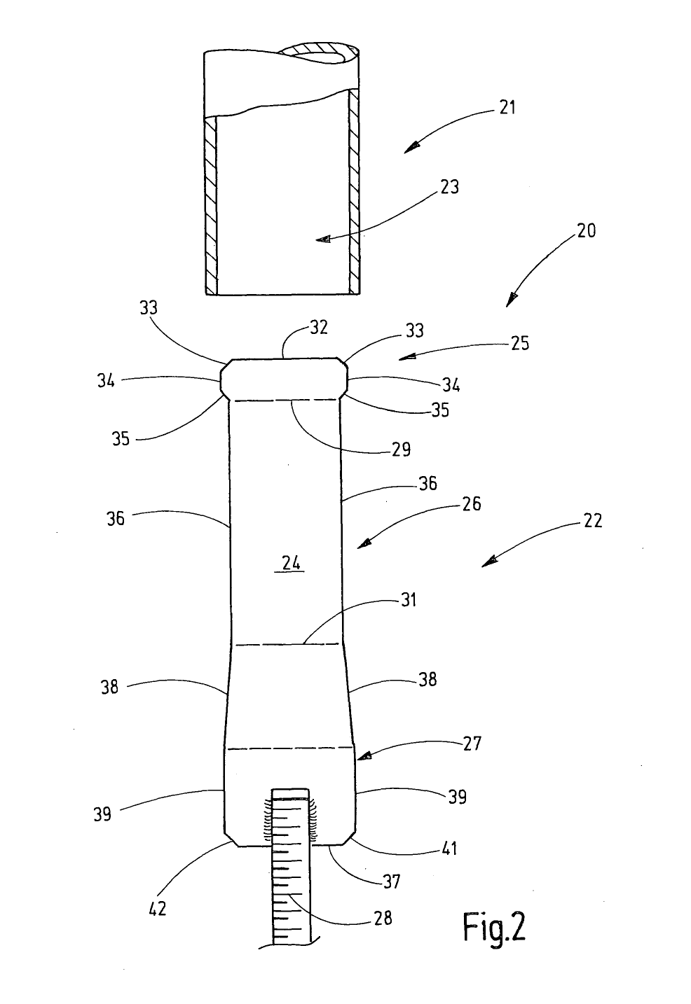

Each connection mechanism 20, as shown in FIG. 2, includes a receptacle socket 21 and an insertion post 22. The receptacle socket 21 is formed by the lower end of the vertical leg 15 of the bent tube 12 of the headboard 11. The tube or the receptacle socket 21 forms a cylindrical, smooth inner space 23.

The illustrated insertion post 22 essentially is a laser cut part cut from a steel plate of corresponding thickness with the outer contours as viewed in FIG. 2. Accordingly, one of the two flat sides 24 is shown in FIG. 2. The flat sides 24 run parallel to the longitudinal axis of the insertion post 22 and are located the same distance from the longitudinal axis. The thickness of the insert post 22 equals approximately 8 to 10 mm.

The insertion post 22 has an upper support section 25, a waist section 26, as well as a lower support section 27. The lower support section 27 has a rectangular recess in which a threaded post 28 is welded for securing the post 22 on the head end of the upper frame 4 of the lifter 2.

The upper support section 25 transitions theoretically at a dashed line 29 into the waist section 26. The boundary between the waist section 26 and the support section 27 is depicted by a dashed line 31. Both transition lines run perpendicular to the longitudinal axis of the insertion post 22.

The upper support section 25 theoretically has the form of an elongated hexagon whose lower edge is depicted by the dashed line 29 and whose upper end edge 32 runs parallel to the lower edge at a right angle to the longitudinal axis of the insertion post 22. It effectively is the edge of the upper narrow surface of the plate-shaped insertion post 22.

On both sides, the elongated edges 32,29 are connected by short straight edges 33, 34, and 35 on the left side. Corresponding edges are located mirror-inverted on the other side of the post 22, because the insertion post 22 is symmetric to the longitudinal axis with respect to the visible outer contours running in the vertical direction. Therefore, the edges located on the other side of the insertion post 22 carry the same reference symbols.

The waist section 26 has, in contrast, in the side view on the flat side 24 of the insertion post 22, the construction of a rectangle that is bound by straight edges 36 in the direction parallel to the longitudinal axis and in the transverse direction by the dashed lines 29,31 that represent the theoretical transition from the upper support section and the lower support section, respectively, to the waist section. Because the two side edges 36 lie, in turn, in mirror-inverted relation to the longitudinal axis, they also carry the same reference symbols 36. The lower support section 27 is, again, hexagonal. It is bound at the top by the dashed line 31 and at the bottom by the lower end edge 37. The lateral boundary edges are the edges 38, 39, and 41, likewise mirror-symmetric to the longitudinal axis, which is why the corresponding edges are provided on the right side with the same reference symbols.

In the region of the upper support section 25, the edges 34 visible in FIG. 2 are simultaneously the corners of the rectangular profile cross section. The diagonals of this profile cross section intersect at the longitudinal axis of the insertion post 22. The distance between the corners of the edges 34, i.e., the length of the diagonals, is selected so that they are shorter, for example, between 0.5 and 3 mm, advantageously between 0.5 and 1.5 mm, preferably by 1 mm, than the diameter of the cylindrical inner space 23 of the receptacle socket 21. In this way, the upper support section 25 in the receptacle space 23 obtains a slight play parallel and transverse to the flat sides 24. Because the distance of the flat sides 24 from each other, i.e., the thickness of the insertion post 22 perpendicular to the plane of the drawing is smaller approximately by the factor of 3 than the diameter of the receptacle space 23, the upper support section 25 has less play in the direction parallel to the plane of the drawing than at a right angle.

The edges 33,35 are used as chamfers in order to allow simpler insertion and to prevent, in the case of an oblique placement, the area of the upper support section 25 bounded by the edges 34 from being able to become jammed in the receptacle space 23.

The width of the waist section 24 measured between its two vertical longitudinal edges 36 is selected so that, when the headboard 11 is put in place, the handlebar 12 and the insertion post 22 cannot become jammed.

For the lower support section 27, what has been stated in connection with the side edges 34 for the upper support section 25 applies with respect to the transverse dimensions between the side edges 39. The side edges 39 run on each side exactly in extension of the side edges 34 of the upper support section 25. The length of the side edges 38 is selected so that the angle that the side edges 38 with the longitudinal axis is approximately 4°. Through the side edges 38, the lower support section is basically pointed upward.

The lower, oblique edges 41 have the purpose of ensuring that, in the case of tilting, the maximum contact pressure is produced in the handlebar or the receptacle space 23 at a point that is displaced into the space.

The length of the waist section 24 in relation to the region that is defined by the edges 38 is selected so that the insertion post 22 can practically no longer jam in the handlebar 12 when joined with the handlebar 12. The possible tilting angle is too small for self-locking to occur at a given point.

Because the insertion post is manufactured from a flat material, flexural tolerances in the handlebar 12 or in the fastening points of the insertion post 22 can be easily absorbed for the reasons mentioned above. The bow-shaped hold formed by the insertion tube 12 can shift slightly transverse to the bed, but the play is significantly smaller in the direction parallel to the longitudinal axis of the bed. Practically no tilting occurs, because in addition to everything else, the insertion post is relatively long. The distance from the lower edge 37 up to the upper edge 32 preferably is approximately 150 mm.

Instead of the side edges 33 to 35 transitioning into each other at angles in the upper support section 25, a continuously curved edge could also be used here.

If it does not depend on the asymmetry with respect to the play of the insertion post 22 in the receptacle space 23, the profile shown in FIG. 2 could also reproduce the outer contours of a rotationally symmetric insertion post that behaves in the same way as the insertion post made from flat material with respect to the freedom from jamming during joining.

From the foregoing, it can be seen that a hospital bed is provided that has a removable headboard with a handlebar whose free ends rise up on the upper frame of the lifter. For connecting the handbar to the lifter, insertion posts are provided on the lifter. These insertion posts are shaped so that a jamming effect cannot occur when the headboard is placed on the insertion post nor while being pulled down.

1-15. (canceled)

16. A hospital bed (1) comprising,
a bed frame (2),
a headboard (11) at a head end of the bed frame (2),
two connection mechanisms (20) each provided at one side of the bed frame (2) for detachable connecting the headboard (11) to the bed frame (2),
said connection mechanisms (20) each including a tubular receptacle socket (21) that has a cylindrical, smooth inner space (23),
said connection mechanism (20) each further including an insertion post (22) that has two flat sides (24) parallel to each other, and
said insertion posts (20) being removably positionable in said tubular receptacle sockets (21).

17. A hospital bed according to claim 16 in which said insertion post (22) has a rectangular cross sectional profile.

18. A hospital bed according to claim 17 in which said cross sectional profile is sized such that diagonal of the cross-sectional profile of the insertion post (22) that runs at a right angle to a longitudinal axis of the insertion post (22) has a length that is shorter than an inner diameter of the tubular receptacle socket (21).

19. A hospital bed according to claim 16 in which said insertion post (22) is formed with two support sections (25, 27) that are spaced apart from each other along a longitudinal length of the insertion post (22).

20. A hospital bed according to claim 19 in which each support section (25, 27) has a diagonal length that runs at a right angle to a longitudinal axis of the insertion post, and the longest diagonal length of said support sections (25,27) being shorter between 0.5 mm and 3 mm that an inner diameter of the tubular receptacle socket (2).

21. A hospital bed according to claim 19 in which one of the two support sections (25, 27) is arranged adjacent one end of the insertion post (22) and the other support section (22) is arranged adjacent the other end of the insertion post (22).

22. A hospital bed according to claim 19 in which one of the support sections (25, 27) is pentagonal or hexagonal as viewed onto a flat side (24) thereof, and said flat side (24) has longitudinal edges (34, 39) that run parallel to a longitudinal axis of the insertion post (22).

23. A hospital bed according to claim 22 in which one of the support sections (25, 27) has edges (33, 35; 38, 41) that are rounded or oblique as viewed onto the flat side (24) thereof.

24. A hospital bed according to claim 19 in which support sections (25, 27) have equal maximum widths in a plane of a flat side (24) of the support sections.

25. A hospital bed according to claim 19 including a waist section (26) arranged between the two support sections (25, 27), said waist section having a width measured in the plane of the flat side (24) that is smaller than the width of the support sections (25, 27) measured in the same plane.

26. A hospital bed according to claim 25 in which said waist section (26) is bounded by straight edges (36) as viewed onto the flat side (24).

27. A hospital bed according to claim 16 in which the distance between the flat sides (24) of the insertion post (22) is between 5 mm and 15 mm.

28. A hospital bed according to claim 16 in which the insertion post (22) is provided on the bed frame (2).

29. A hospital bed according to claim 16 in which the receptacle socket (21) is formed by a tube (12) of the headboard (11).

30. A hospital bed comprising,
a bed frame (2),
a headboard (11) at a head end of the bed frame (2),
connection mechanisms (20) on opposite both sides of the bed frame (2) for detachabl connecting the headboard (11) to the bed frame (2),
said connection mechanisms (20 each including a tubular receptacle socket (21) that has a cylindrical, smooth inner space (23) and a rotationally symmetric insertion post (22) that has two support sections (25, 27) spaced apart from each other and a waist section (26) between the support sections whose diameter is smaller than the diameter of the support sections (25, 27), and
said support sections (25, 27) having a predetermined diagonal length perpendicular to a longitudinal axis of the insertion post with the greatest diagonal length of the support sections (25, 27) being between 0.5 mm and 3 mm smaller than an inner diameter of the receptacle socket (23).
